(19) United States
(12) Patent Application Publication
(10) Pub. No.: US 2023/0041655 A1
(43) Pub. Date: Feb. 9, 2023

(54) SLAP PAY AND SNAP PAY CONTACTLESS PAYMENT AND DATA SYSTEMS

(71) Applicant: David Sterling, Greenwich, CT (US)

(72) Inventor: David Sterling, Greenwich, CT (US)

(21) Appl. No.: 17/394,570

(22) Filed: Aug. 5, 2021

(51) Int. Cl. G06Q 20/32; G06Q 40/00

(52) U.S. Cl. CPC G06Q 20/321; G06Q 20/3274; G06Q 20/3278; G06Q 40/125

(57) ABSTRACT

A system for processing electronic information is disclosed. The system includes a bracelet including a chip, a scannable code on the outer surface of the bracelet, and a PIN number on the inner surface of the bracelet. The system also includes a backend system for processing activation of the bracelet, for processing payments by a user of the bracelet, processing payroll payments to the user, processing access entry to a venue, or processing access to a cloud server. An interface is provided between the bracelet and the backend system. The interface receives data stored in the chip, the scannable code, or the PIN number.

### FIELD OF THE INVENTION

The present invention generally relates to electronic transaction processing involving use of snap or slap bracelets.

### BACKGROUND

Payment for goods and services is shifting from physical currency to digital currency, and eventually all modernized societies will utilize digital payment methods instead of physical payment methods for the majority of retail transactions. Contactless digital payment systems are gaining popularity, and the general public has begun the process of widespread adoption. There are now multiple ways for consumers to utilize contactless technologies. They can be used for a range of applications including payments, admissions, data storage, and identification.

COVID-19 has created acute sensitivity to coming in contact with surfaces, and consumers want ways to pay which they feel are safe. The safest way to complete a transaction is to not come in contact with a surface. Small businesses have begun widespread adoption of contactless technologies as a way of providing a safer experience for their employees and customers. Visa's recent “Back to Business” study showed that 82% of small business respondents had embraced digital technology by the end of 2020, and almost all expect contactless payments to increase.

There are several large companies which have developed contactless payment systems. They include Visa (Visa Wearables), Apple (Apple Pay), Google (Google Pay), Samsung (Samsung Pay), Garmin (Garmin Pay), and Fitbit (Fitbit Pay). These companies are all offering products which are meant to be reusable, and some devices cost hundreds of dollars. None have made the leap to offering digital payment products which are wearable, free (or very inexpensive), and available to all potential consumers.

Therefore, in view of these disadvantages, there is a need in the art for an improved system and method to process electronic transactions.

### SUMMARY

The following presents a simplified summary of the invention in order to provide a basic understanding of some aspects of the invention. This summary is not an extensive overview of the invention. Rather than specifically identifying key or critical elements of the invention or to delineate the scope of the invention, its purpose, inter alia, is to present some concepts of the invention in a simplified form as a prelude to the more detailed description that is presented later.

The present disclosure relates to a system for processing a number of transactions. The system includes a bracelet including a chip, a scannable code on the outer surface of the bracelet, and a PIN number on the inner surface of the bracelet. The system also includes a backend system for processing activation of the bracelet, for processing payments by a user of the bracelet, processing payroll payments to the user, processing access entry to a venue, or processing access to a cloud server. An interface is provided between the bracelet and the backend system. The interface receives data stored in the chip, the scannable code, or the PIN number.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following description of the invention when considered in conjunction with the drawings.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a snap bracelet in accordance with one embodiment;

FIG. 2 illustrates a slap bracelet in accordance with one embodiment;

FIG. 3 illustrates a system for accepting payments in accordance with one embodiment;

FIG. 4 illustrates a system for access entry in accordance with one embodiment; and

FIG. 5 illustrates a cloud storage system in accordance with one embodiment.

### DETAILED DESCRIPTION

The foregoing summary, as well as the following detailed description of certain embodiments of the subject matter set forth herein, will be better understood when read in conjunction with the appended drawings. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that variations may be made without departing from the scope of the subject matter disclosed herein. It should also be understood that the drawings are not necessarily to scale and in certain instances details may have been omitted, which are not necessary for an understanding of the disclosure, such as details of fabrication and assembly. Furthermore, references to “one embodiment” are not intended to be interpreted as excluding the existence of additional embodiments that also incorporate the recited features. The following detailed description is, therefore, not to be taken in a limiting sense, and the scope of the subject matter disclosed herein is defined by the appended claims and their equivalents.

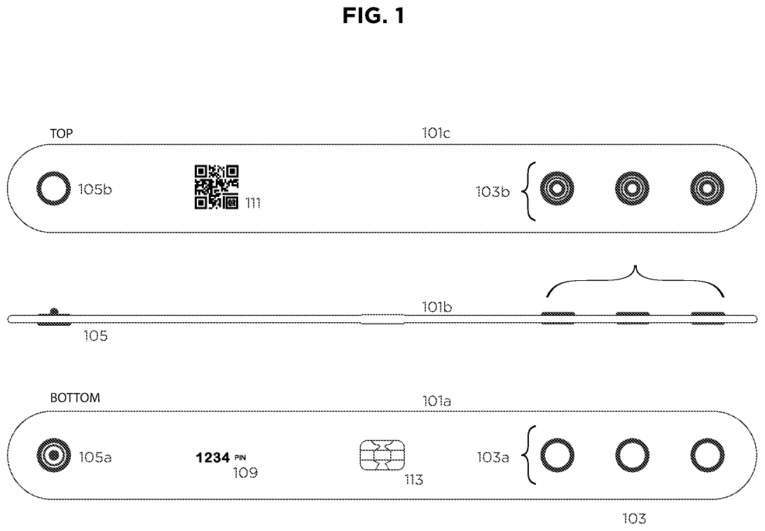

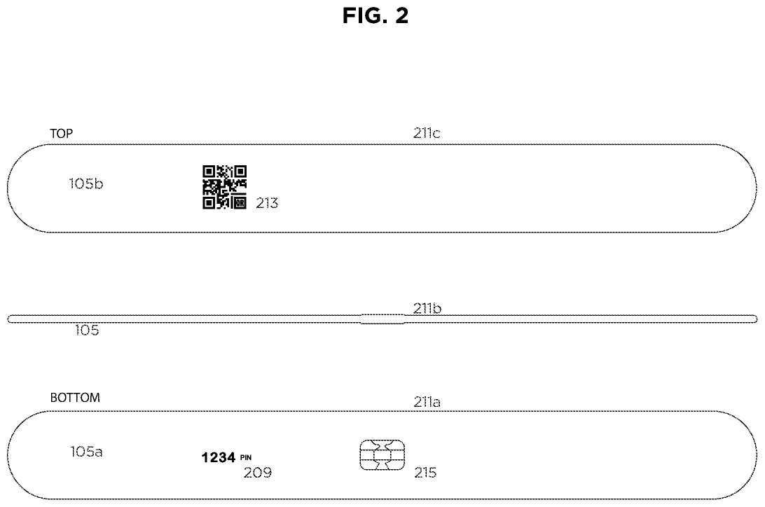

The present disclosure describes a system that solves the problems with the prior art. That system involves use of a “snap” bracelet (referred herein as “snap pay bracelet” or “snap bracelet”), and of a “slap” bracelet (referred herein as “slap pay bracelet” or “slap bracelet”). An exemplary snap bracelet is shown in FIG. 1 and an exemplary slap bracelet is shown in FIG. 2. The system is referred to as the Slap Pay and/or Snap Pay global payment and data storage platform. The slap pay bracelet and snap pay bracelet may include a digital microchip. Both models may work on contactless payment terminals that recognize digital payment chips. Visa, Mastercard, Amex and Discover have all developed contactless payments infrastructures which could be used or easily be adapted to implement payment transactions through use of the bracelets described in the present disclosure.

In one embodiment, slap pay bracelet and/or the snap pay bracelet may embed an NFC enabled digital microchip and meant to be disposable. Because the cost of a NFC payment chip is only a fraction of a penny, the most basic form of the product has a nominal production cost. The cost is so low that in one embodiment non-reloadable bracelets can be sold in low denominations. The nominal entry threshold for consumers means that many economically disadvantaged individuals throughout the world would be to use the slap pay and snap pay bracelets to access the digital financial system.

In other embodiments, the slap pay bracelet and/or the snap pay bracelet may include a small compartment and a hatch on the underside for the insertion and removal of a smart microchip. These bracelets may be offered with pre-paid reloadable balances. In addition, the digital microchip may be used for data storage, which means that there are multiple other applications for the smart bracelet system across industries including banking, ticketing, insurance, and hospitality.

Conventional slap bracelets have been available for many years—they cost very little and are a popular children's toy (https://www.claires.com/us/jewelry/bracelets/slap-bracelets/). One advantage of the snap pay and slap pay bracelets of the present invention is that children will be able to complete purchases through use of the bracelets and parents will be able log into their Slap Pay or Snap Pay account to see all of the purchases made with the pay bracelets which are linked to their account. Not only can parents see how their children are spending their money, but they would be able to block future spending if the bracelet is lost or if their children are spending too much. The snap pay and slap pay bracelets may be stamped with or may feature images and logos, providing opportunities for licensing, endorsements, and alignments with various marketing partners.

The Slap Pay and Snap Pay systems may be based on US Dollars. In another embodiment, the systems may be implemented abroad and be based on multiple currencies. Thus, the Slap Pay and Snap Pay platform may be launched in multiple markets, and will be available in local currencies. The platform also works well for foreign exchange, as the customer could exchange paper currency for the local currency, and then have the value credited to the pay bracelet. Not only does the transaction accomplish the goal of currency conversion, but the customer goes from having a dirty paper currency to a clean and wearable contactless digital currency.

The disclosed bracelets may be manufactured a layered, flexible stainless steel spring bands sealed within a fabric, silicone, or plastic cover, with an embedded pre-loaded NFC chip. These can be used (for activation or to make purchases, for example) at any merchant location with an NFC-enabled payment terminal. Use of the disclosed bracelets does not require use of a smart phone.

In other embodiments, the Slap Pay and Snap Pay bracelets may include a small compartment and a hatch on the underside for the insertion and removal of a digital NFC-enabled SIM card. These bracelets may be offered with pre-paid reloadable balances.

The customer can use the number and/or smart code printed on the underside of the Slap Pay or Snap Pay bracelet to register their payment bracelet online through a “Pay Bracelet Enrollment Hub”. Once the pay bracelet has been registered online there are multiple other applications for the smart bracelet system across industries including currency exchange, general banking, ticketing and admissions, payroll processing, insurance, and hospitality

FIG. 1 illustrates a snap bracelet in accordance with one embodiment. FIG. 1 illustrates three different views of a snap bracelet: a bottom view 101a, a side view 101b, and an upper view 101c. The snap bracelet includes several snap buttons 103a-b, any one of which may be plugged into snap button 105a-b to secure the bracelet to a person's wrist in accordance with one embodiment. A QR code 111 or bar code may be printed on the top surface of the snap bracelet for ease of access by a QR or bar code scanner. The snap bracelet may also include a PIN number 109 printed on the bottom surface of the bracelet, which may be used to activate the bracelet. Also, the snap bracelet may include a smart chip, an NFC chip, or a chip integrating the NFC functionality into a smart chip 113 which may be used to complete payment transactions at a point-of-sale.

FIG. 2 illustrates a slap bracelet in accordance with one embodiment. FIG. 2 illustrates three different views of a slap bracelet: a bottom view 211a, a side view 211b, and an upper view 211c. The slap bracelet may be secured to a person's wrist in accordance with one embodiment, as would be recognized by persons skilled in the art. A QR code 213 or bar code may be printed on the top surface of the slap bracelet for ease of access by a QR or bar code scanner. The slap bracelet may also include a PIN number 209 printed on the bottom surface of the bracelet, which may be used to activate the bracelet. Also, the slap bracelet may include a smart chip, an NFC chip, or a chip integrating the NFC functionality into a smart chip 215 which may be used to complete payment transactions at a point-of-sale.

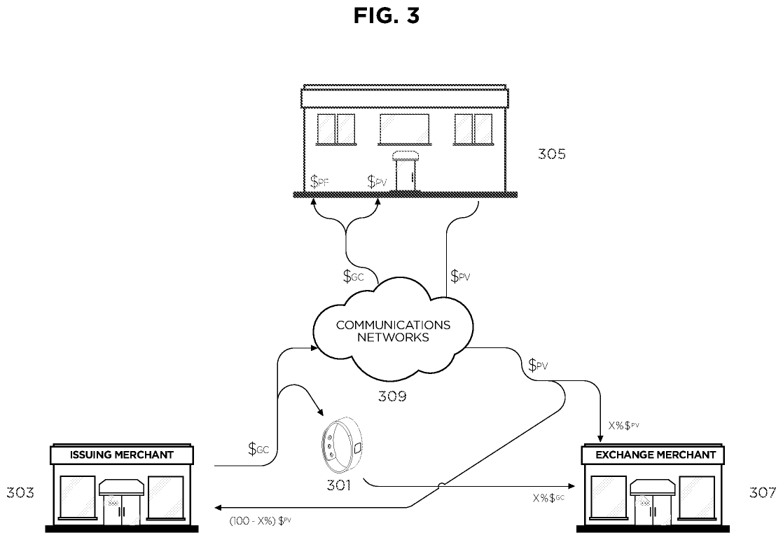

FIG. 3 illustrates a system for accepting payments in accordance with one embodiment. A gift card processing system using the disclosed bracelets is disclosed.

In one embodiment, the Slap Pay & Snap Pay system may be used for payments. The snap pay and slap pay bracelets may include a smart code and/or a PIN number printed on the underside. The PIN number may be covered in a heat resistant HRV-6541 coating which is a 100% reactive UV curable flexographic coating designed for use on plastics and can withstand temperatures of up to 350 F. Once the PIN number has been exposed, the snap pay or slap pay bracelet can be used for payment on any NFC-enabled chip reader.

The Slap Pay Bracelets and Snap Pay Bracelets may use the same activation process as most department store gift cards. Gift cards issued by department stores typically have a PIN. It is usually found on the back of the card underneath an area that must be scratched off to view. This scratch-off area (implemented with the UV curable flexographic coating in one embodiment of the disclosed bracelets) helps prevent the PIN number from being stolen before the pay bracelet is authorized, enabled, or activated. After the Slap Pay Bracelet or Snap Pay Bracelet is activated by the selling merchant on an NFC enabled payment terminal, it can be used without the PIN number. In one embodiment, the bracelet is active until the balance is exhausted.

In one embodiment, a Slap Pay or Snap Pay bracelet is made available to consumers wrapped in a clear plastic packaging, with a smart code and PIN printed on the underside. The consumer can use the smart code and PIN to register their pay bracelet online. The system may rely on NFC-enabled contactless payment terminals, which can be used to either process a payment, or to increase the amount of money loaded onto the Slap Pay or Snap Pay bracelet.

The PIN number and smart code may function as a digital key to the interface with the backend online system. Once the consumer creates an online profile, the customer will be able to use the Snap Pay/Slap Pay system for various applications, including adding funds to the payment bracelets, and to suspend access to funds (primarily for parental control).

Referring to FIG. 3, a customer first purchases a pay bracelet 301 through any merchant, such as a issuing merchant 303 or a secondary bracelet vendor, such as a supermarket, a convenience store, and the like. The merchant issued bracelet 301 may be assigned a unique identifier, such as a 12-16 digit reference number or character set similar to a number assigned to the pay bracelet to link the bracelet 301 to an account. The unique identifier may be provided in an electronically readably format. The electronically readably format can be provided via an embedded programmable circuit, and the like. For example, the unique identifier may be stored in the pay bracelet's smart chip in one embodiment.

The merchant issued bracelet 301 may include the name or other identifier (such as a logo) of the issuing merchant 303 or any other type of advertising material. In addition, the merchant issued bracelet 301 may include an identifier (such as a logo) representative of the clearinghouse 305 (e.g., Visa, Mastercard, etc.). The merchant issued bracelet 301 can have a pre-established value or have a value established at the time of purchase, wherein the pay bracelet value is referenced as $GC. The value $GC of the merchant issued bracelet 301 can be adjusted in accordance with transactions, lower than and up to the established, pending value of the merchant issued bracelet 301 at the time of the transaction.

The card reference number, the issuing merchant information, and respective value $GC are conveyed to a clearinghouse 305 through a communications network. The information transfer step 204 utilizes a communication network 309 for communicating between various locations, such as the issuing merchant 303 and the clearinghouse 305. The actual monetary amount $GC is transferred from the issuing merchant 303 (or other actual card retailer) to the clearing house 305 via any physical or electronic funds transferring means known by those skilled in the art. The value $GC of the merchant issued bracelet 301 may be apportioned into a processing fee $PF and a processed value $PV. The processing fee $PF may be a small percentage of the initial card value $GC provided to the clearinghouse 305 for managing the merchant issued bracelet 301 value and effecting any transaction. The clearinghouse 305 receives the processing fee $PF. The effective value $PV of the merchant issued bracelet 301 is placed into an account for payment of a future transaction in accordance with a pay bracelet/gift card valuation banking process.

To complete a purchase using the pay bracelet, the bracelet 301 may be presented to a point-of-sale (“POS”) device at a merchant's facility. For example, the NFC chip embedded on the pay bracelet may be used to exchange data (e.g., the unique identifier) with an NFC reader of the POS device, in accordance with one embodiment. In another embodiment the QR code printed on the pay bracelet may be scanned by a QR reader of the POS device such that the POS device can acquire the unique identifier associated with the pay bracelet.

The merchant issued bracelet 301 can be used for a value of up to the pay bracelet value $GC. In one embodiment, for a transaction utilizing the maximum value of the merchant issued bracelet 301, the merchant receives an amount being the pay bracelet/gift card value $GC subtracting the processing fee $PF, which equals the effective value $PV. Should the transaction be less than the maximum value of the merchant issued bracelet 301, the merchant receives the amount of the transaction, subtracting a percentage respective to the processing fee $PF. The clearinghouse 305 to a merchant (for example, issuing merchant 303) payment process is referred to as a merchant payment process.

Also illustrated in FIG. 3 is a foreign merchant 307 (designated as exchange merchant), which may be defined as a merchant in a foreign country. The purchaser can also complete a purchase transaction in a foreign country in accordance with one embodiment. If the customer or holder of the pay bracelet desires to make a purchase at the exchange merchant 307, the customer can use the merchant issued bracelet 301 for completing a payment transaction as described above, with the exception that the transaction will be completed at the exchange rate set by the exchange merchant 307.

In one embodiment, the exchange merchant 307 can determine the adjusted pay bracelet/gift card monetary value x %$GC, wherein x % is representative of the exchange rate. The adjusted gift card monetary value x %$GC may be deducted from the total amount of the transaction. The exchange merchant 307 communicates with the clearinghouse 305 via the communication network 309, requesting information pertaining to the merchant issued bracelet 301. The transaction provides the reference number of the merchant issued bracelet 301, and in turn requests validation of the merchant issued bracelet 301, the exchange rate x %, and the pending balance $.GC, and then the exchange merchant 307 continues with the transaction. Upon completion of the transaction, the monetary value x %$PV is transferred from the clearinghouse 305 to the exchange merchant 307 via an exchange merchant payment process.

There are several additional main banking functions which can be done utilizing the Slap Pay and Snap Pay platform illustrated in FIG. 3. For general banking services a “Snap Pay” bracelet model with a reloadable chip and a security snap at the ends of the strap may be used. One potential banking application for the Slap Pay & Snap Pay platform is payroll. The Slap Pay and Snap Pay platforms are a fast and convenient way for employers to pay their employees. Payroll payments made through the Slap/Snap Platform may be credited immediately to the employee's Slap Pay/Snap Pay account. This system is much faster and more convenient than traditional paper-based payroll systems which have a lag between when the payment is issued and when the funds are credited to the recipients' account.

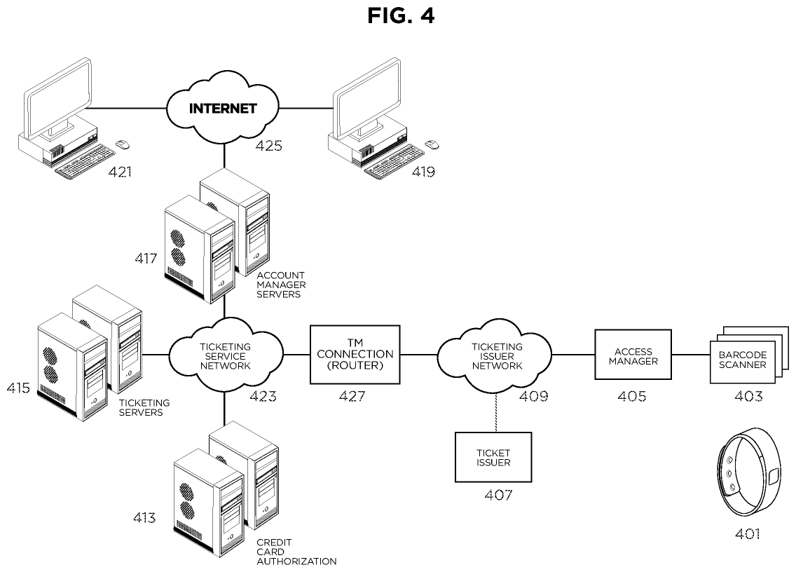

FIG. 4 illustrates a system for access entry using the pay bracelets in accordance with one embodiment. Specifically, FIG. 4 illustrates exemplary hardware components and software components that can be invoked during the processes for use of the disclosed bracelets to permit access or admission to a venue. An example ticketing system operated by a ticket processing service or other entity can include ticketing servers 415, account manager servers 417, a credit card authorization system 413, a network, 423, and a router 427. The ticketing system can host a Web site accessible by users of the disclosed bracelets for purchasing, selling, and transferring tickets.

As depicted, users of the bracelets may access the ticket processor ticketing system over the Internet 425 using respective PCs 421, 419. In addition, or alternatively, users can access the ticketing system via other general-purpose computers that have access to the Internet, via networked personal digital assistants, phones, interactive televisions, or other user terminal types. The user terminals 421, 419 may run commercially-available Web browser applications, such as those which implement the basic World Wide Web standards such as HTTP and HTML, or other types of applications that access data from networked sites.

The user terminals 421, 419 may also run a commercially available e-mail application, which may be used to receive communications from the ticketing system. The e-mail application and the browser may be integrated with one another, and/or may be integrated with other application programs or the operating system. The terminals 421, 419 can include displays, keyboards, memory storage devices, printers, and the like. In one embodiment, when mobile devices are used in lieu of terminals 421, 419, the mobile device may run an application that allows linking the slap pay or snap pay bracelets to the ticketing application, such that when a ticket is purchased or acquired for permitting access to a venue, the ticket information is uploaded to the bracelets via a smart chip embedded with the bracelet or through an NFC chip embedded with the bracelet, which may communicate with the mobile device to transfer the ticket information. Alternatively, the ticket information may be linked to a QR code of the bracelet through an application such that the bracelets do not require uploading of ticket information, but rather the ticket information would reside in the backend servers and can be accessed for permitting access to a venue when the QR code of the bracelet 401 is scanned at the venue's location through QR/barcode scanner 403. When the ticket information is uploaded into the bracelet 401, the ticket information may be accessed through an NFC reader embedded with scanner 403.

The ticket processing ticketing system can include one or more databases, such as a user account database, that stores user contact information, billing information, preferences, account status, and the like, that can be accessed by other portions of the ticketing system, such as by account manager servers 417. Similarly, one or more ticket databases accessible by the ticketing system can include ticket information records for tickets, including QR/barcode information, event name, event date, seat identifier, ticket holder name or other identifier of a current ticket holder, names, or other identifiers of past holders of the ticket, a ticket valid/invalid indicator, and an indicator that as to whether the ticket has been used.

As further depicted by FIG. 4, a ticket issuer, which can be a sports team, venue operator, ticketing agency, or the like, accesses the ticketing system via the router 427. The ticket issuer can have a ticket issuer ticket system 407 that hosts an application, such as Ticketmaster's commercially available Archtics™ application, that may be used to define events, set ticket prices, and provide real-time integration with the ticket processor ticketing system. In addition, via the system 407, the ticket issuer can optionally define customized invoices, tickets, receipts, labels, and other correspondence. The system 407 optionally allows the ticket issuer to define at least portions of the Web pages that will be displayed to users, such as by defining logos, fonts, colors, and the like.

The system 407 is connected to an intranet and/or the Internet 409 to thereby access the router 427, access management system 405, and to receive data from a QR/barcode scanner 403. In one embodiment, the access management system 405 may be implemented as the server-based Access Manager™ system that is commercially available from Ticketmaster. The access management system may be used to authenticate electronic ticket proffered at an event venue through use of the bracelet 401.

The access management system 405 utilizes the QR code/barcode information scanned from a bracelet 401 using the scanner 403 to perform the authentication. The access management system servers can optionally use a database and/or an encryption/decryption algorithm for ticket identification lookup. By way of example, the ticket issuer ticketing system 407 generates ticket QR codes or barcodes.

The ticket issuer then sells tickets, such as season tickets, either directly or via the ticketing service ticket processing system. For example, the ticket issuer can authorize payment via the bracelet 401, a credit card, debit charge, or otherwise. Tickets may be posted, via the account manager 417, for sale on the Web site hosted by the ticketing system. A record of the posting can be stored in the ticket database, which can be stored on the ticketing system 407, the account manager servers 417, and/or the ticketing servers 415.

A user of the bracelet can initiate, authorize payment, and complete a purchase of one or more of the posted tickets via the user terminal 421 or a mobile device. If the user is paying by credit card or the bracelet 401, the credit card authorization system 413 checks to make sure the credit card and/or pay bracelet 401 is authorized and has not exceeded its credit limit or balance.

When the user of the bracelet 401 attempts to access entry to a venue through use if the scanner 403, the access management system 405 will compare the scanned QR code/barcode information with that stored in the access management system database, and determine whether the ticket information is valid (e.g., has not been used before to gain access).

The slap bracelet system may be utilized for ticketing and admissions (referred herein as the Slap Ticket or Snap Ticket system). The bracelet may include a QR code or bar code for scanning at a venue where admission is sought, and an embedded digital smart chip. The Slap Pay and Snap Pay platforms can utilize pre-existing scanning technologies and can be integrated into pre-existing access control systems. Benefits of the Slap Ticket and Snap Ticket system over traditional printed tickets and electronic tickets are:
The Slap/Snap Ticket can be worn, versus a paper ticket which cannot be worn
The Slap/Snap Ticket does not require an additional device, versus an electronic ticket which requires a phone
The Slap/Snap Ticket is a more permanent memento than paper tickets
Information for other venue-based add on sales such as parking, pre-paid merchandise may be pre-loaded onto the embedded smart chip
Almost limitless customizable promotions may be uploaded onto a Slap/Snap Ticket while a paper ticket only has space for a single promotional offer
Slap/Snap Ticket may be highly personalized, versus a paper ticket which quite often looks generic

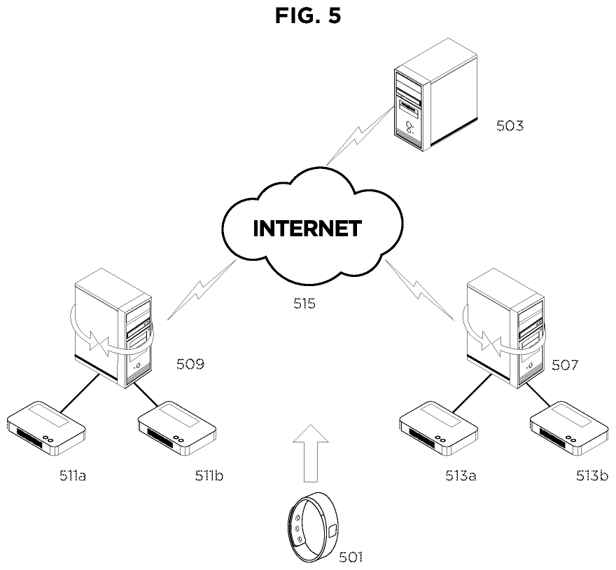

FIG. 5 illustrates a cloud storage system in accordance with one embodiment.

Since the Slap Pay Bracelets and Snap Pay Bracelets utilize smart chip technology, they may be used for data storage. In one embodiment, they function like a portable hard drive, and the re-usable versions of the bracelets may include smart chips with varying amounts of data storage capacity.

Another smart application for the bracelet platform is for cloud storage. For this purpose, the data may be stored in the cloud and/or on the Slap/Snap Pay bracelet.—or only in the cloud The smart chip may act as a key, which in combination with a pin or biometric scan, may provide access to the user's cloud data.

Referring to FIG. 5, a network structure is illustrated according to an example of the disclosure. A cloud server 503 may establish connection with several intelligent gateways located in different areas via Internet. For instance, the cloud server 503 may connect with intelligent gateway 509 and intelligent gateway 507, respectively. Relay devices 511a and 511b may access a network through the intelligent gateway 509, and relay devices 513a and 513b may access a network through the intelligent gateway 507. Bracelet 501 may support many wireless authentication protocols. In a unified authentication mode, if intend to access several different WLANs, bracelet 501 may be subject multiple wireless access authentications according to the wireless authentication protocols supported by wireless APs of each WLAN. For instance, in case that relay devices 511a-b and 513a-b are based on different authentication protocols, when a bracelet 301 those relay devices (through NFC connection, for example), the user of the bracelet will perform predetermined authentication action for the bracelet according to the respective authentication protocols of the relay devices, such as inputting a password for authentication authority, entering the PIN, scanning a QR code through an interface or through the smart chip embedded in the bracelet.

According to the method for wireless access authentication, an intelligent gateway may be previously associated with account information of an account registered on the intelligent gateway on a cloud server. The account information may include identity information such as a username, password for verification authority, and information of a trusted terminal device corresponding to the account. When receiving an access authentication packet, the intelligent gateway may construct an identity verification packet by using authentication identification of a terminal device to access a WLAN, which is carried in the access authentication packet, and identity information (such as a username) of an account previously registered on the intelligent gateway. When the cloud server determines the bracelet corresponding to the access authentication identification as a trusted bracelet according to the access authentication identification and the association account identification, the bracelet corresponding to the access authentication identification is permitted to pass the access authentication. Consequently, when the bracelet intends to access multiple different WLANs, this method may be used for unified authentication instead of security verification for each WLAN. In this way, operations on wireless access authentication can be reduced and less authentication information during the authentication process will be generated, which avails to intelligent gateway management. This in turn, allows access of data stored in the cloud server through an authentication process used by the bracelet.

The Snap Pay and Slap Pay bracelets have additional applications. Many central banks throughout the world are developing their own digital tokens which are referred to as “Central Bank Digital Currencies” (CBDCs). CBDCs can either be used by consumers and business (Retail CBDCs) or in interbank transactions (Wholesale CBDCs). CBDCs can be used or the issuance, distribution and exchange of monetary units between banks, financial service providers, and individuals.

There are currently over 50 CBDCs which are being developed worldwide. The Bahamian “Sand Dollar” is the most developed CBDC. The Central Bank of The Bahamas began issuing the Sand Dollar in October 2020. The Sand Dollar is a digital version of the Bahamian Dollar. It holds identical legal status as the standard currency.

CBDCs are fast, efficient, and secure. The CBDC system also reduces the cost of financial services, and builds inclusion for people of all ages and socioeconomic status. Other benefits of CBDCs are control over money laundering, counterfeiting, and other cash-enabled fraud.

According to the Bahamian Central Bank's webpage, “it also provides an excellent record of income and spending.” Users of the Bahamian Sand Dollar access their digital wallets through a mobile application or a physical payment card. Recently, MasterCard™ and the Bahamian Government launched the world's First Central Bank Digital Currency-Linked Card. The Bahamian “Sand Dollar Prepaid Card” gives people the option to use the Bahamian fiat currency the “Sand Dollar” to pay for goods and services anywhere MasterCard is accepted on the Islands and around the world.

The MasterCard™ “Sand Dollar Prepaid Card” is supported by blockchain technology. MasterCard™ will support digital currencies directly on its network, and is in crypto partnerships including Wirex, Uphold, BitPay, LVL. The network which MasterCard™ has developed to support digital currencies may be used to support the Snap Pay and Slap Pay systems. In the future there will be many other companies which develop systems to support digital currencies, and major projects are underway at Visa™, American Express™, and other payment processing companies.

The Slap Pay and Snap Pay system disclosed herein may be used by central banks to distribute their “Central Bank Digital Currencies” (CBDCs) to their citizens. For example, government entities may mail the Slap Pay Bracelets and Snap Pay Bracelets to their citizens directly for disbursements such as social security payments.

The foregoing description of possible implementations consistent with the present disclosure does not represent a list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims. Further, the limitations of the following claims are not written in means-plus-function format and are not intended to be interpreted based on 35 U.S.C. 112(f), unless and until such claim limitations expressly use the phrase “means for” followed by a statement of function void of further structure.

1. A system for processing electronic information comprising:
a bracelet comprising a chip, a scannable code on the outer surface of the bracelet, and a PIN number on the inner surface of the bracelet;
a backend system for processing activation of the bracelet, for processing payments by a user of the bracelet, processing payroll payments to said user, processing access entry to a venue, or processing access to a cloud server; and
an interface between said bracelet and said backend system, wherein the interface receives data stored in said chip, said scannable code, or the PIN number.

2. The system of claim 1, wherein said bracelet is a snap bracelet or a slap bracelet.

3. The system of claim 1, wherein said chip comprises an NFC chip.

4. The system of claim 1, wherein said bracelet includes a compartment and a hatch on the inner surface of the bracelet for receiving said chip.

5. The system of claim 1, wherein said bracelet is made of a layered, flexible stainless steel spring band sealed within a fabric, silicone, or plastic cover.

6. The system of claim 1, wherein said PIN number is covered with a heat resistant coating.

7. The system of claim 6, wherein said coating comprises a HRV-6541 coating.

8. The system of claim 6, wherein said coating comprises a reactive UV curable flexographic coating.

9. A bracelet for processing electronic information comprising:
a chip;
a scannable code on the outer surface of the bracelet; and
a PIN number on the inner surface of the bracelet;
wherein said bracelet exchanges data with a backend system through an interface, the data comprising data stored in said chip, said scannable code, or the PIN number; and
wherein the backend system processes processing activation of the bracelet, payments by a user of the bracelet, payroll payments to said user, access entry to a venue, or access to a cloud server.

10. The bracelet of claim 9, wherein said bracelet is a snap bracelet or a slap bracelet.

11. The bracelet of claim 9, wherein said chip comprises an NFC chip.

12. The bracelet of claim 9, wherein said bracelet includes a compartment and a hatch on the inner surface of the bracelet for receiving said chip.

13. The bracelet of claim 9, wherein said bracelet is made of a layered, flexible stainless steel spring band sealed within a fabric, silicone, or plastic cover.

14. The bracelet of claim 9, wherein said PIN number is covered with a heat resistant coating.

15. The bracelet of claim 14, wherein said coating comprises a HRV-6541 coating.

16. The bracelet of claim 14, wherein said coating comprises a reactive UV curable flexographic coating.

17. The system of claim 1, wherein said chip is preloaded with a monetary balance.

18. The bracelet of claim 9, wherein said chip is preloaded with a monetary balance.
